(19) United States
(12) Patent Application Publication
(10) Pub. No.: US 2018/0025311 A1
(43) Pub. Date: Jan. 25, 2018

(54) SYSTEM AND METHOD FOR MANAGING ONE OR MORE INVENTORIES

(71) Applicant: Dexter Herbert Thomas, Elk Grove, CA (US)

(72) Inventor: Dexter Herbert Thomas, Elk Grove, CA (US)

(21) Appl. No.: 15/218,114

(22) Filed: Jul. 25, 2016

(51) Int. Cl. G06Q 10/08; G06K 7/10; G06F 17/30; G06Q 30/00; G06Q 50/22; G06Q 50/12; G06Q 30/06; H04W 4/00

(52) U.S. Cl. CPC G06Q 10/087; G06Q 30/0633; G06Q 10/083; G06K 7/10881; G06K 7/10861; H04W 4/008; G06Q 30/018; G06Q 50/22; G06Q 50/12; G06F 17/30312; G06F 17/30368

(57) ABSTRACT

An inventory management system to manage inventories of business/organizations by a user is provided. The inventory management system is attached to a handheld scanner to scan products. The details of the products are stored in a database. In one embodiment, the user may be a manager or admin personal of the business/organization. The inventory management system an alert to the user via emails if (i) the quantities of the products are getting low, and/or (ii) the date is crossing the best-by-date of the products. The user orders the products when the quantities of the products are getting low. The user orders the products from the business/organization to deliver to the one or more customers.

### BACKGROUND

### Technical Field

The embodiments herein generally relate to an inventory management system, and, more particularly, to a system and method for allowing businesses and organizations to keep up-to-date with their inventories and purchases.

### Description of the Related Art

One of the important tasks in order for many businesses or organizations to work efficiently is to keep an ardent eye on the availability of all the items in the inventory. A failed inventory management in businesses such as hotels, restaurants, etc leads to delays in the services being offered, eventually resulting in customer dissatisfaction. So, if in case, there is no up-to-date record of the goods being sold in a business/organizations, the unavailability of the items at the time of high demand will have the customers waiting for long before finally receiving the order.

The automation of inventory management is equally indispensable. Counting the quantity of each type of item in an inventory on a daily basis, ordering the inventory items in case of deficiency, keeping track of expiry dates of the items, delivering orders to the customers, etc are some of the tasks which when performed manually increases the labor costs significantly. Additionally, the bigger problems are the amount of time it may consume and the errors that may incur.

A number of methods have been posed previously in the direction of inventory management but none integrate the solutions to all the above mentioned problems in a single system.

Accordingly, there remains a need for an effective system and method which will help the owners of different businesses and organizations to stay well aware of their inventories and purchases.

### SUMMARY

In view of the foregoing embodiment herein provides an inventory management system to manage inventories of one or more business/organizations. The inventory management system is attached to a handheld scanner to scan one or more products. In one embodiment, the handheld scanner may a bar code scanner, a RFID scanner, a Bluetooth scanner, or a NFC scanner. The handheld scanner may be connected to the user computing device by (i) wired connection and/or (ii) wireless connection. In one embodiment, the handheld scanner is connected with the user computing device using (i) a Bluetooth technology, (ii) a Wi-Fi technology, and/or (iii) a Zig-Bee technology. In one embodiment, the user may be a manager or admin personal of the one or more business/organization. In another embodiment, the one or more business/organization may be, but not limited to, (i) one or more restaurants, (ii) one or more hospitals, and/or (iii) any retails stores.

The inventory management system includes a database, an input program module, an alert program module, an inventory order program module, an order program module, and a display module. The input program module is configured to provide details of the one or more products using the handheld scanner. The handheld scanner scans a bar code on the one or more products. The bar code includes the details, but not limited to, a price of the one or more products, an expiry date of the one or more products, and a manufacturing date of the one or more products. The details of the one or more products are stored in the database.

The alert program module configured to provide alert to the user if, but not limited to, (i) the quantities of the one or more products are getting low, and/or (ii) the date is crossing the best-by-date (i.e., expiry date of the one or more products). In one embodiment, the alert is given to the user via (i) emails on predefined email id using the internet, messages on predefined mobile number, and/or (iii) a pop-up display on the display module.

The inventory order module configured to order the one or more products by the user when the quantities of the one or more products are getting low. In one embodiment, the inventory order module configured to order the one or more products from one or more predefined vendors. In one embodiment, the one or more products may be (i) food items in case of the inventory management system is used in the one or more restaurants, (ii) medical items in case of the inventory management system is used in the one or more hospitals.

The order module is configured to order the one or more products from the one or more business/organization by the user to deliver to the one or more customers. In one embodiment, the order module sends the order details to the kitchen in case of the inventory management system is used in the one or more restaurants. The display module is configured to display (i) the quantities of the one or more products, and (ii) the pop-up alert display when the (a) the quantities of the one or more products are getting low, and/or (b) the date is crossing the best-by-date of the one or more products (i.e., expiry date of the one or more products).

In another aspect, a method of managing one or more inventories of a business/organization is provided. The method includes following steps: (i) one or more products are scanned using a handheld scanner by a user; (ii) the information of the one or more products is stored to the database; (iii) the inventory management system checks whether needs to scan more products; (iv) if yes more products are scanned using the handheld scanner in step (i); (v) if not the quantity of the one or more products are accessed; (vi) the inventory management system checks whether the quantity of the one or more products are getting low or not; (vii) If the quantity of the one or more products is getting low an alert is sent to the user and more products are ordered from the vendors in step; and (viii) If the quantity of the one or more products are not getting low the products are ordered by one or more customers.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a system view of an inventory management system implemented in a user computing device to manage inventories of one or more business/organizations according to an embodiment herein;

FIG. 2 illustrates an exploded view of the inventory management system of FIG. 1 according to an embodiment herein;

FIG. 3 illustrates a diagrammatic representation of the handheld scanner of FIG. 1 according to an embodiment herein;

FIG. 4 is a user interface view of the inventory management system of FIG. 1 according to an embodiment herein;

FIG. 5 illustrates a user interface view of the wrist inventory scanner to scan the one or more products of FIG. 1 according to an embodiment herein;

FIG. 6 illustrates a user interface view of the inventory kiosk in case of the inventory management is used in one or more restaurants according to an embodiment herein;

FIG. 7 is a flow diagram illustrating a method of managing one or more inventories of a business/organization according to an embodiment herein;

FIG. 8 illustrates an exploded view of the computing device of FIG. 1 according to the embodiments herein; and

FIG. 9 illustrates a schematic diagram of computer architecture used in accordance with the embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

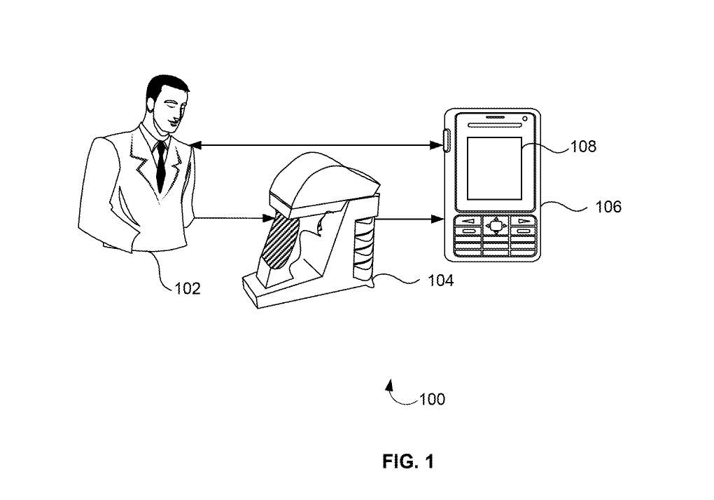

As mentioned, there remains a need for a system and method which will help the owners of different businesses and organizations to stay well aware of their inventories, orders and purchases. The embodiments herein achieve this by providing an inventory management system with a handheld scanner/wrist inventory scanner. Referring now to the drawings, and more particularly to FIGS. 1 through 9, where similar reference characters denote corresponding features consistently throughout the figures, there are shown preferred embodiments.

FIG. 1 illustrates a system view 100 of an inventory management system 108 implemented in a user computing device 106 to manage inventories of one or more business/organizations according to an embodiment herein. The system view 100 includes a user 102, a handheld scanner 104, the computing device 106, and the inventory management system 108. The user 102 interacts with the handled scanner 104, and the user computing device 106 to provide details of one or more products. In one embodiment, the handled scanner scans a bar code on the one or more products. In another embodiment, the user computing device may be (i) a mobile phone, (ii) a computer, or (iii) a laptop. In one embodiment, the handheld scanner 104 may a bar code scanner, a RFID scanner, a Bluetooth scanner, or a NFC scanner. In one embodiment, a wrist inventory scanner (not shown in FIG. 1) is used instead of the handheld scanner 104. The handheld scanner 104 may be connected to the user computing device 106 by (i) wired connection and/or (ii) wireless connection. In one embodiment, the handheld scanner 104 is connected with the user computing device 104 using (i) a Bluetooth technology, (ii) a Wi-Fi technology, and/or (iii) a Zig-Bee technology. In one embodiment, the user 102 may be a manager or admin personal of the one or more business/organization. In another embodiment, the one or more business/organization may be, but not limited to, (i) one or more restaurants, (ii) one or more hospitals, and/or (iii) any retails stores.

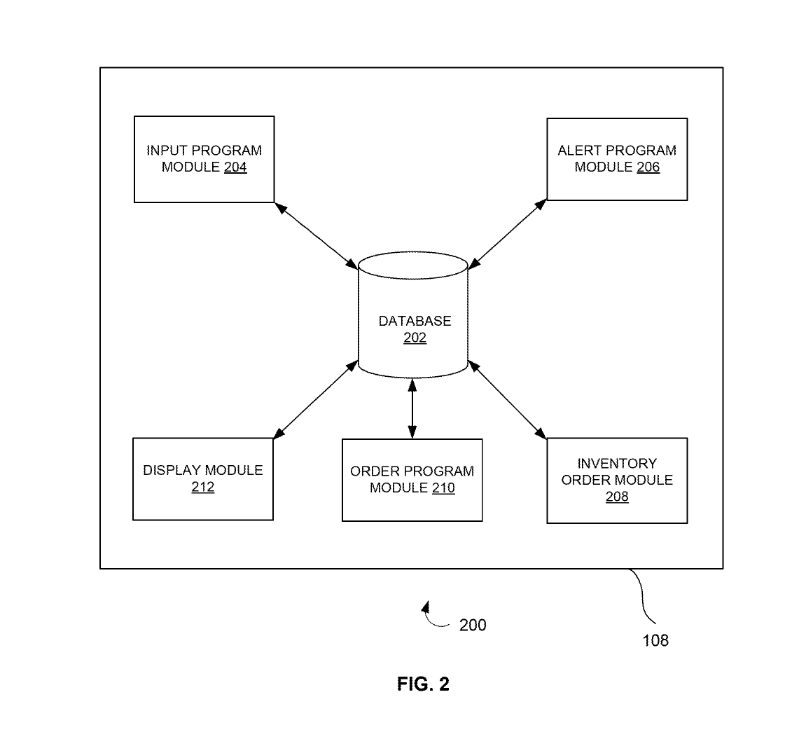

FIG. 2 illustrates an exploded view 200 of the inventory management system 108 of FIG. 1 according to an embodiment herein. The exploded view 200 includes a database 202, an input program module 204, an alert program module 206, an inventory order program module 208, an order program module 210, and a display module 212. The input program module 204 is configured to (i) allow the user 102 to login into the inventory management system 108, and (ii) provide details of the one or more products using the handheld scanner 104. In one embodiment, the user 102 uses a unique login id to login into the inventory management system 108. The handheld scanner 104 scans a bar code on the one or more products. The bar code includes the details, but not limited to, prices of the one or more products, an expiry date of the one or more products, and a manufacturing date of the one or more products. The details of the one or more products are stored in the database 202.

The alert program module 206 configured to provide alert to the user 102 if, but not limited to, (i) the quantities of the one or more products are getting low, and/or (ii) the date is crossing the best-by-date of the one or more products (i.e., expiry date of the one or more products). In one embodiment, the alert is given to the user 102 via (i) emails on predefined email id using the internet, (ii) messages on predefined mobile number, and/or (iii) a pop-up display on the display module 212.

The inventory order module 208 configured to order the one or more products by the user 102 when the quantities of the one or more products are getting low. In one embodiment, the inventory order module 208 configured to order the one or more products from one or more predefined vendors. In one embodiment, the one or more products may be (i) food items in case of the inventory management system 108 is used in the one or more restaurants, (ii) medical items in case of the inventory management system 108 is used in the one or more hospitals.

The order module 210 is configured to order the one or more products from the one or more business/organization by the user 102, and the one or more products are delivered to the one or more customers. In one embodiment, the order module 210 sends the order details to the kitchen in case of the inventory management system 108 is used in the one or more restaurants. In one embodiment, the handheld scanner 104/the wrist inventory scanner scans the one or more products which are to be delivered to the one or more customer and updates in the database 202. The display module 212 is configured to display (i) the quantities of the one or more products, and (ii) the pop-up alert display when the (a) the quantities of the one or more products are getting low, and/or (b) the date is crossing the best-by-date (i.e., expiry date of the one or more products). In one embodiment, the display module 212 is an inventory kiosk that displays the availability of the one or more products and allows the one or more customers to select the one or more products.

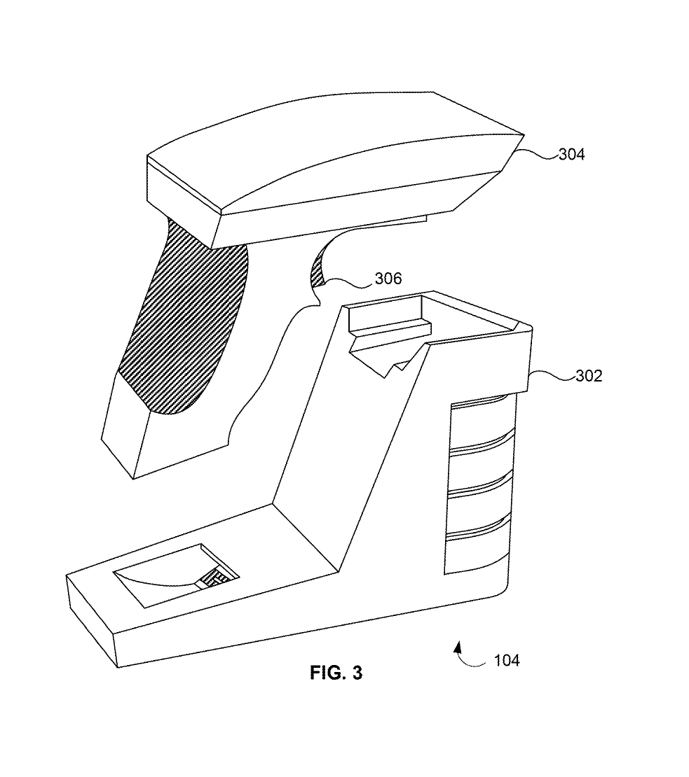

FIG. 3 illustrates a diagrammatic representation of the handheld scanner 104 of FIG. 1 according to an embodiment herein. The handheld scanner 104 is a barcode scanner. The handheld scanner 104 includes a scanner charging base 302, a scanning head 304, and a push/trigger button 306. The scanner charging base 302 is adapted to charge, and hold the scanning head 304. The scanning head 304 is configured to scan one or more barcodes on the one or more products when the user 102 pushes the push/trigger button 306. In one embodiment, the scanning head 304 includes a laser beam to scan the one or more barcodes of the one or more products. The scanning head 304 transfers the scanned one or more barcodes to the inventory management system 108 using the wireless technology. In one embodiment, the wireless technology may be a Bluetooth technology and/or a zig-bee technology.

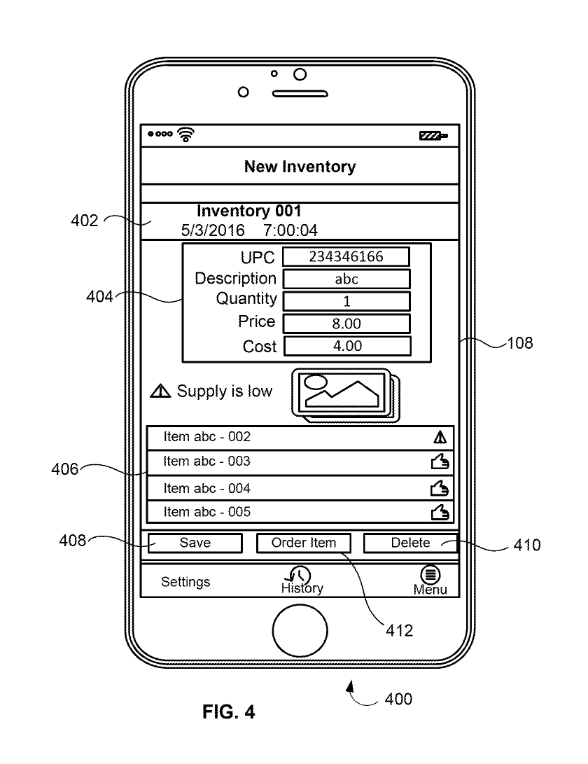

FIG. 4 is a user interface view 400 of the inventory management system 108 of FIG. 1 according to an embodiment herein. The user interface view 400 includes an inventory tab 402, an inventory details tab 404, an inventory list 406, a save tab 408, a delete tab 410, and an order item tab 412. When the user 102 scans the one or more products using the handheld scanner 104, the name of at least one product from the one or more products is shown in the inventory tab 402. The inventory details tab 404 is configured to display a set of details of the at least one product from the one or more products. In one embodiment, the set of details includes but not limited to an UPC code, descriptions of the product, quantity of the product, and/or price of the product.

The inventory list 406 displays whether the one or more products are in sufficient quantity or not in the inventory management system 108. In one embodiment, the inventory list 406 displays a unique symbol for the products which are in insufficient quantity. The save tab 408 is configured to allow the user 102 to add the one or more products to the database 102 of the inventory management system 108. The delete tab 410 is configured to allow the user 102 to delete the one or more products from the database 202. The order item tab 412 is configured to order the one or more products from the predefined vendors. In one embodiment, the inventory management system 108 allows the user 102 to change the predefined vendors.

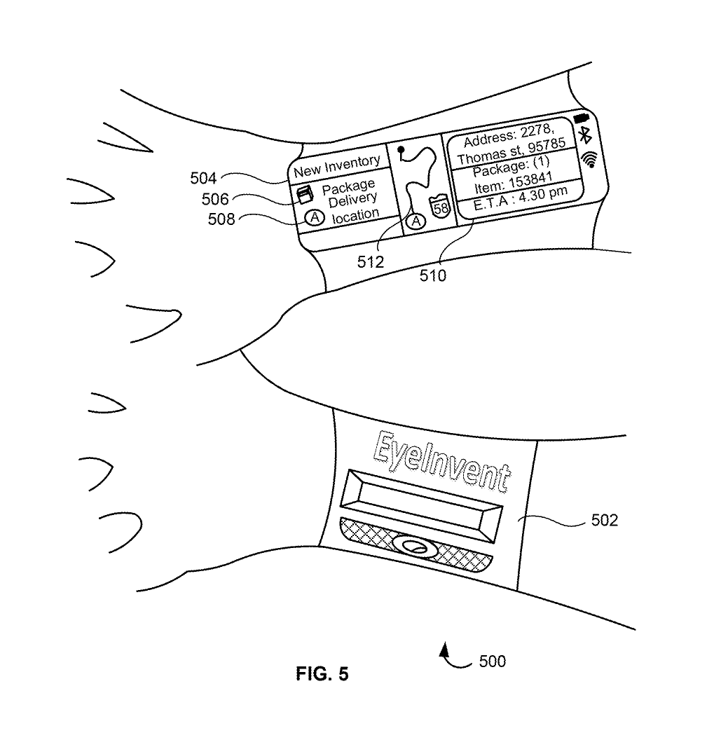

FIG. 5 illustrates a user interface view of the wrist inventory scanner 500 to scan the one or more products of FIG. 1 according to an embodiment herein. The wrist inventory scanner 500 includes a welcome screen 502, a new inventory tab 504, a package tab 506, a delivery location tab 508, a delivery details tab 510, and a map tab 512. The wrist inventory scanner 500 is adapted to couple to the wrist of the user 102. The welcome screen 502 displays an Eyelnvent logo. The new inventory tab 504 is configured to scan the one or more products to add into the database 202. The package tab 506 is configured to enter no. of packages to be delivered by the user 102. The delivery location tab 508 is configured to enter delivery location of the one or more customers. The delivery details tab 510 is configured to provide details that includes, but not limited to, address of the delivery location, the package details, and an estimated arrival time of the one or more product at delivery location. The map tab 512 directs the user 102 to the delivery location. In one embodiment, the wrist inventory scanner 500 is connected to the inventory management system 108 via (i) the Bluetooth, will, or (iii) ZigBee technology.

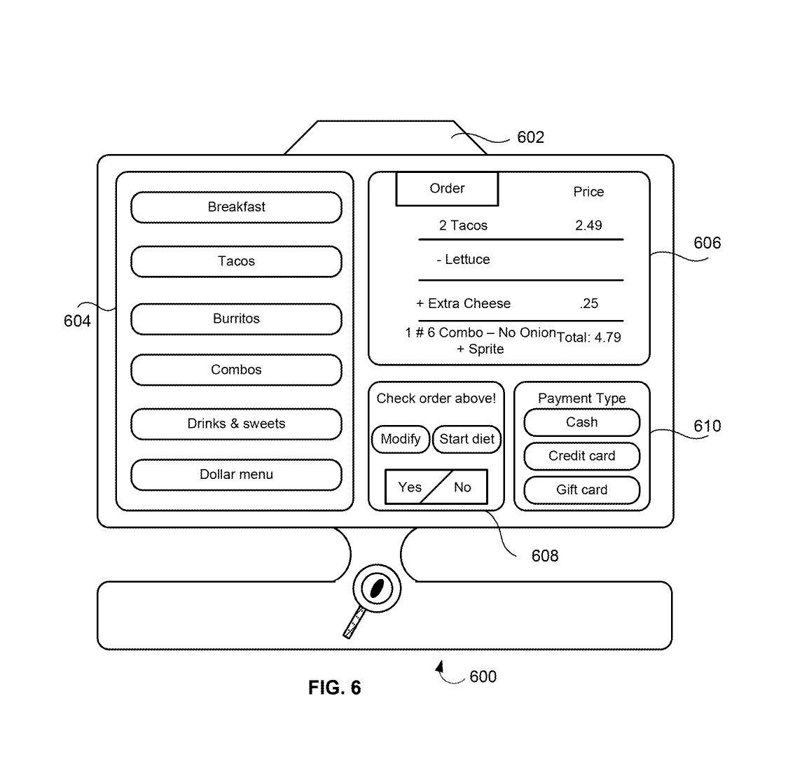

FIG. 6 illustrates a user interface view of the inventory kiosk 600 in case of the inventory management 108 is used in one or more restaurants according to an embodiment herein. The inventory kiosk 600 displays the availability of the one or more products and allows the one or more customers to select the one or more products. The inventory kiosk 600 includes a logo tab 602, a food type selection tab 604, an order input tab 606, an order tab 608, and a payment tab 610. The logo type 602 configured to display one or more logos of the one or more business/organization. The food type selection tab 604 is configured to select a type of food by the one or more customers. In one embodiment, the type of food is, but not limited to, breakfast, tacos, burritos, combos, drinks & sweets, and/or dollar menu. The order input tab 606 is configured to enter one or more foods. For example, the one or more customers orders two tacos with extra cheese and six combos and the order is displayed with price. The order tab 608 is configured to confirm the order by clicking yes button. In one embodiment, the order tab 608 allowed the one or more customer to modify the order by clicking order button. The payment tab 610 configured to make payment for the ordered food by three modes. The mode of payment may (i) by cash, (ii) by a credit card, and/or (iii) a gift card.

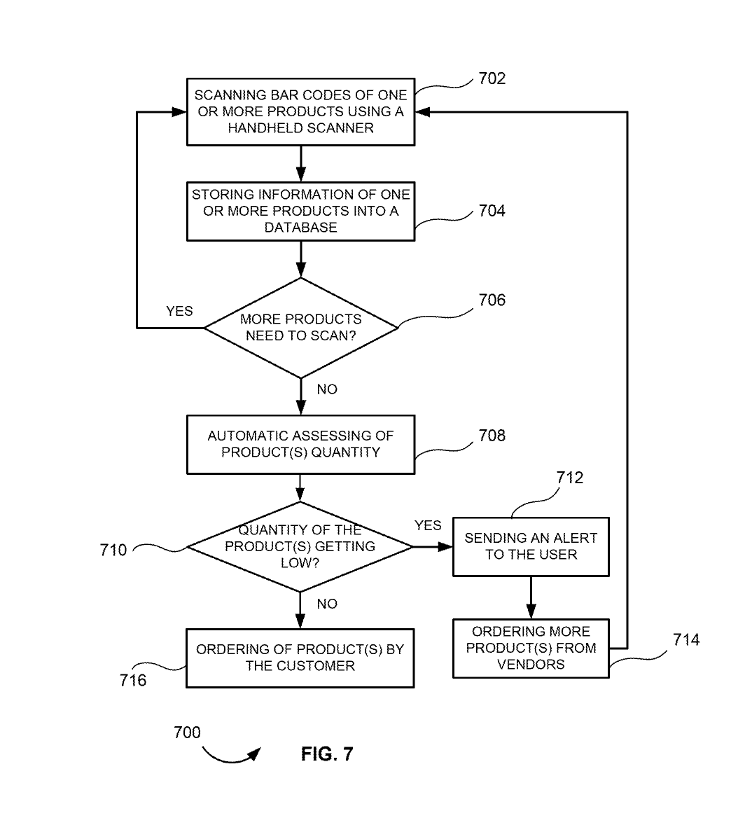

FIG. 7 is a flow diagram 700 illustrating a method of managing one or more inventories of a business/organization according to an embodiment herein. In step 702, one or more products are scanned using a handheld scanner 104 by a user 102. In step 704, the information of the one or more products is stored to the database 202. In step 706, the inventory management system 108 checks whether needs to scan more products, if yes more products are scanned in the step 702, if not the quantity of the one or more products are accessed in step 708. In step 710, the inventory management system 108 checks whether the quantity of the one or more products are getting low or not. If the quantity of the one or more products is getting low an alert is sent to the user 102 in step 712 and more products are ordered from the vendors in step 714. If the quantity of the one or more products are not getting low the products are ordered by one or more customers in step 716.

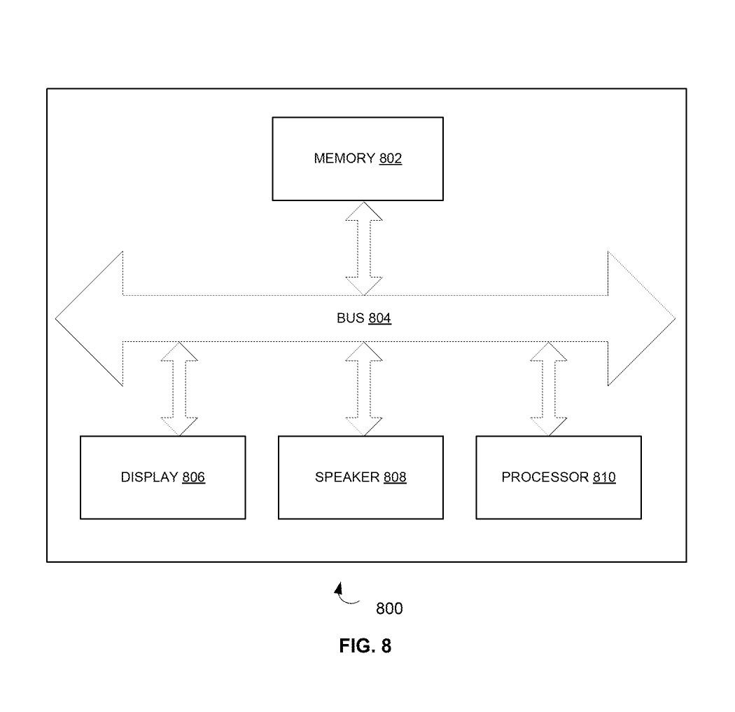

FIG. 8 illustrates an exploded view of the computing device 106 having an a memory 802 having a set of computer instructions, a bus 804, a display 806, a speaker 808, and a processor 810 capable of processing a set of instructions to perform any one or more of the methodologies herein, according to an embodiment herein. In one embodiment, the receiver may be the computing device 106. The processor 810 may also enable digital content to be consumed in the form of video for output via one or more displays 806 or audio for output via speaker and/or earphones 808. The processor 810 may also carry out the methods described herein and in accordance with the embodiments herein.

Digital content may also be stored in the memory 802 for future processing or consumption. The memory 802 may also store program specific information and/or service information (PSI/SI), including information about digital content (e.g., the detected information bits) available in the future or stored from the past. A user of the personal communication device may view this stored information on display 806 and select an item of for viewing, listening, or other uses via input, which may take the form of keypad, scroll, or other input device(s) or combinations thereof. When digital content is selected, the processor 810 may pass information. The content and PSI/SI may be passed among functions within the personal communication device using the bus 804.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly.

The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can take the form of, an entirely hardware embodiment, an entirely software embodiment or an embodiment including both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, remote controls, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

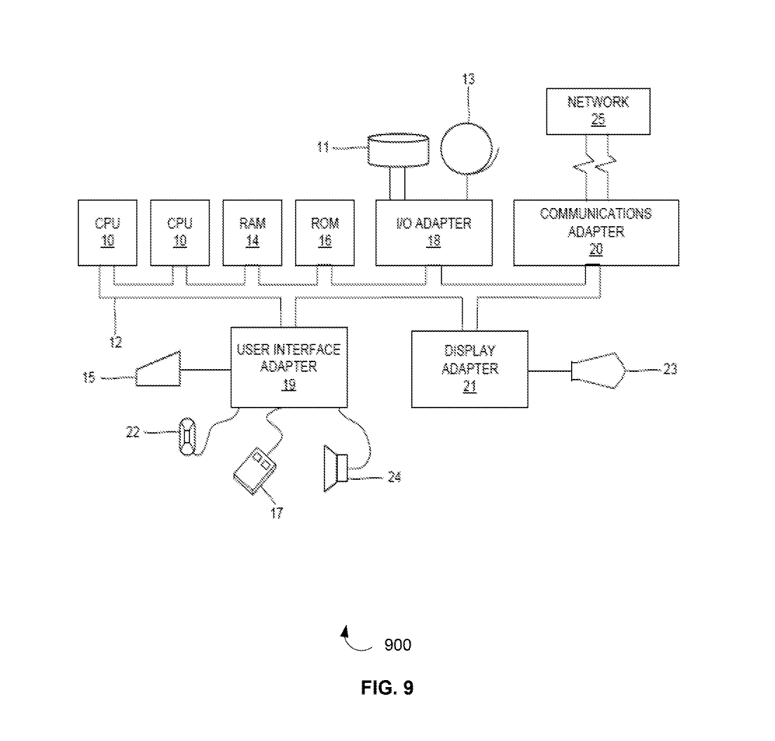

A representative hardware environment for practicing the embodiments herein is depicted in FIG. 9. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope.

What is claimed is:

1. An inventory management system with a handheld scanner that allows a user to manage inventories of a plurality of business or organizations, wherein said inventory management system comprises:
a memory unit that stores a database, and a plurality of modules;
a processor that processes said plurality of modules, wherein said plurality of modules comprises:
an input program module, executed by said processor, that is configured to (i) allow said user to login into said inventory management system, and (ii) provide a plurality of details of a plurality of products by scanning a bar code present on said plurality of products, wherein said handheld is configured to scan said bar code;
an alert program module, executed by said processor, that is configured to provide an alert to said user if (i) quantities of said plurality of products are getting low, or (ii) date on said plurality of products is crossing the expiry date of said plurality of products;
an inventory order module, executed by said processor, that is configured to order said plurality of products by said user when said quantities of said plurality of products are getting low;
an order program module, executed by said processor, that is configured to order said plurality of products from said plurality of business or organization by said user to deliver to a plurality of customers; and
a display unit that is configured to display (i) said quantities of said plurality of products, and (ii) a pop-up alert display on a user computing device when (a) said quantities of said plurality of products are getting low, or (b) the date is crossing the expiry date of said plurality of products.

2. The inventory management system of claim 1, wherein said inventory management system is implemented in said user computing device.

3. The inventory management system of claim 1, wherein said handheld scanner is connected to said user computing device by (i) wired connection, or (ii) wireless connection to scan said plurality of products.

4. The inventory management system of claim 3, wherein said handheld scanner is connected to said user computing device using (i) a Bluetooth technology, (ii) a Wi-Fi technology, or (iii) a Zig-Bee technology.

5. The inventory management system of claim 1, wherein said handheld scanner is a (i) a bar code scanner, (ii) an RFID scanner, (iii) a Bluetooth scanner, or (iv) an NFC scanner.

6. The inventory management system of claim 1, wherein said user is a manager or admin personnel of said plurality of business or organizations.

7. The inventory management system of claim 6, wherein said plurality of business or organizations are (i) a plurality of restaurants, (ii) a plurality of hospitals, or (iii) any retail stores.

8. The inventory management system of claim 1, wherein said bar code holds said plurality of details comprising (i) a price, (ii) an expiry date, or (iii) a manufacturing date of said plurality of products.

9. The inventory management system of claim 1, wherein said alert is given to said user via (i) emails on predefined email id using the internet, (ii) messages on predefined mobile number, or (iii) a pop-up display on said display unit.

10. The inventory management system of claim 1, wherein said plurality of products are (i) food items when said inventory management system is used in said plurality of restaurants, or (ii) medical items when said inventory management system is used in said plurality of hospitals.

11. A method for managing inventories of a plurality of business or organizations using a handheld scanner, wherein said method comprises:
providing a plurality of details of a plurality of products by scanning a bar code present on said plurality of products;
storing said plurality of details of said plurality of products into a database;
providing an alert to said user if (i) quantities of said plurality of products are getting low, or (ii) date on said plurality of products is crossing the expiry date of said plurality of products;
ordering said plurality of products by said user when said quantities of said plurality of products are getting low; and
ordering said plurality of products from said plurality of business or organization by said user to deliver to a plurality of customers.

12. The method of claim 11, wherein said alert is sent to said user via (i) emails on predefined email id using the internet, (ii) messages on predefined mobile number, or (iii) a pop-up display on a display unit of a user computing device.

13. The method of claim 11, wherein said bar code holds said plurality of details comprising of (i) a price, (ii) an expiry date, or (iii) a manufacturing date of said plurality of products.

14. A non-transitory program storage device readable medium by a computer, and comprising a program of instruction executable by said computer to perform a method for managing inventories of a plurality of business or organizations using a handheld scanner, wherein said method comprises:
providing a plurality of details of a plurality of products by scanning a bar code present on said plurality of products;
storing said plurality of details of said plurality of products into a database;
providing alert to said user if (i) quantities of said plurality of products are getting low, or (ii) date on said plurality of products is crossing the expiry date of said plurality of products;
ordering, from a plurality of vendors, said plurality of products by said user when said quantities of said plurality of products are getting low; and
ordering said plurality of products from the said plurality of business or organization by the said user to deliver to a plurality of customers.

15. The non-transitory machine-readable medium of claim 14, wherein said alert is sent to said user via (i) emails on predefined email id using the internet, (ii) messages on predefined mobile number, or (iii) a pop-up display on a display unit of a user computing device.

16. The non-transitory machine-readable medium of claim 14, wherein said bar code holds said plurality of details comprising (i) a price, (ii) an expiry date, or (iii) a manufacturing date of said plurality of products.
